(19) United States
(12) Patent Application Publication
(10) Pub. No.: US 2025/0292320 A1
(43) Pub. Date: Sep. 18, 2025

(54) DATA CAPTURE AND LOAN PAYOFF THROUGH SMARTPHONE

(71) Applicant: Wells Fargo Bank, N.A., San Francisco, CA (US)

(72) Inventors: Shelli Ulrich, San Francisco, CA (US); Matthew C. Strader, San Francisco, CA (US)

(73) Assignee: Wells Fargo Bank, N.A., San Francisco, CA (US)

(21) Appl. No.: 18/607,184

(22) Filed: Mar. 15, 2024

(51) Int. Cl. G06Q 40/03; G06Q 20/32

(52) U.S. Cl. CPC G06Q 40/03; G06Q 20/3223

(57) ABSTRACT

A method includes authenticating, by a resource of a mobile device, a user for accessing the resource based on user credentials of the user, determining, according to a profile of the user, a set of allowable actions to be taken by the user, determining a list of accounts linked to the profile of the user, receiving an image of an identifier corresponding to a product, the image captured by a camera of the mobile device, extracting characters from the image corresponding to the identifier, initiating a request, to a server, including i) the identifier and ii) information corresponding to the list of accounts, receiving, responsive to the request, data corresponding to the product and displaying information relating to the data which corresponds to the product, including the set of allowable actions permitted to be performed.

### TECHNICAL FIELD

The present disclosure relates to using a smartphone for performing data capture and payoff of a loan instrument.

### BACKGROUND

Many methods for transferring funds, loaning money, and identifying outstanding loan payments exist. Conventionally, a person paying off a loan may do so by submitting a payment via an online banking portal.

### SUMMARY

This disclosure relates to systems, methods, and devices for initiating a loan payoff.

At least one aspect of the disclosure relates to a method. The method includes authenticating, by a resource of a mobile device, a user for accessing the resource based on user credentials of the user. The method further includes determining, by the resource, according to a profile of the user, a set of allowable actions to be taken by the user. The method further includes determining, by the resource, a list of accounts linked to the profile of the user. The method further includes receiving, by the resource, an image of an identifier corresponding to a product, the image captured by a camera of the mobile device. The method further includes extracting, by the resource, characters from the image which correspond to the identifier. The method further includes initiating, by the resource, a request to a server. The request includes i) the identifier and ii) information corresponding to the list of accounts linked to the profile. The method further includes receiving, by the resource from the server, responsive to the request, data corresponding to the product, and displaying, by the resource, information relating to the data from the server which corresponds to the product, including the set of allowable actions permitted to be performed.

In some embodiments, the set of allowable actions includes at least one of receiving information relating to products, initiating a dispute, staging payments, or executing payments.

In some embodiments, the identifier includes at least one of a vehicle identification number, a serial number, an inventory number, a purchase order number, or an identifier corresponding to a bill of lading.

In some embodiments, the information includes a balance due associated with a loan against the product, loan terms of the loan, accrued interest, and an interest rate.

In some embodiments, the method further includes receiving, by the resource, a selection of an action from the set of allowable action, and performing, by the resource, the action according to the selection.

In some embodiments, the action includes executing payment, wherein performing the action comprises initiating, by the resource, a transfer of funds from a first account, according to a payment amount indicated in the data corresponding to the product.

In some embodiments, the action includes staging payment, wherein performing the action comprises adding the identifier to a queue for executing payment for the product by a second user.

In some embodiments, the method further includes the identifier including at least one of a purchase order number or an identifier corresponding to a bill of lading associated with the purchase order, and the action includes initiating a dispute corresponding to the purchase order.

In some embodiments, performing the action includes determining, by the resource, a first count of products corresponding to the purchase order, receiving, by the resource, a second count of received products, and, transmitting, by the resource, to a device, data to initiate to the dispute, the data comprising the first count, the second count, and the identifier.

In some embodiments, the method further includes receiving, by the resource, responsive to receiving the selection and performing the action, a notification indicating completion of the action.

At least one aspect of the disclosure relates to a server comprising one or more processors configured to: receive, from of a resource of a mobile device, a user log in attempt via user credentials of the user, transmit an authentication of the user log in attempt to the resource, retrieve information corresponding to the user profile of the user, where the information corresponding to the user profile of the user is at least one of a set of allowable actions to be taken by the user or a list of accounts linked to the profile of the user, transmit the information corresponding to the user profile of the user to the resource of the mobile device, receive, from the resource, characters that correspond to an identifier of a product, receive a request from the resource, the request comprising i) the identifier and ii) information corresponding to the list of accounts linked to the profile, and transmit, to the resource, responsive to the request, data corresponding to the product.

In some embodiments, the set of allowable actions includes at least one of receiving information relating to products, initiating a dispute, staging payments, or executing payments.

In some embodiments, the identifier includes at least one of a vehicle identification number, a serial number, an inventory number, a purchase order number, or an identifier corresponding to a bill of lading.

In some embodiments, the data corresponding to the product includes a balance due associated with a loan against the product, loan terms of the loan, accrued interest, and an interest rate.

In some embodiments, the one or more processors are further configured to receive, from the resource, a selection of an action from the set of allowable action, and perform, by the server, the action according to the selection.

In some embodiments, the action includes executing payment, wherein performing the action includes initiating, by the server, a transfer of funds from a first account, according to a payment amount indicated in the data corresponding to the product.

In some embodiments, the action includes staging payment, wherein performing the action includes adding the identifier to a queue for executing payment for the product by a second user.

In some embodiments, the identifier includes at least one of a purchase order number or an identifier corresponding to a bill of lading associated with the purchase order, and the action comprises initiating a dispute corresponding to the purchase order. In some embodiments, performing the action includes determining, by the server, a first count of products corresponding to the purchase order, receiving, by the server, a second count of received products, and transmitting, to the resource, by the server, data to initiate to the dispute, the data comprising the first count, the second count, and the identifier.

In some embodiments, the one or more processors are further configured to transmit, to the resource, by the server, responsive to receiving the selection and performing the action, a notification indicating completion of the action.

At least one aspect of the disclosure relates to a device including: one or more processors configured to execute a resource, the resource configured to: authenticate a user for accessing the resource based on user credentials of the user, determine, according to a profile of the user, a set of allowable actions to be taken by the user, determine a list of accounts linked to the profile of the user, receive an image of an identifier corresponding to a product, the image captured by a camera of the device, extract characters from the image which correspond to the identifier, initiate, via a request to a server, the request including i) the identifier and ii) information corresponding to the list of accounts linked to the profile, receive, from the server, responsive to the request, data corresponding to the product, and display information relating to the data from the server which corresponds to the product, including the set of allowable actions permitted to be performed.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a system for initiating a quick loan payoff, according to an example embodiment.

FIG. 2A depicts a method of capturing a product identifier, according to an example embodiment.

FIG. 2B depicts a method of capturing a product identifier, according to an example embodiment.

FIG. 3 depicts an example graphical user interface of a user profile based on scanning a product identifier displayed on a user device, according to an example embodiment.

FIG. 4 depicts an example graphical user interface involving the staging of a loan payment displayed on a customer device, according to an example embodiment.

FIG. 5 is a flowchart of a system for initiating a quick loan payoff, according to an example embodiment.

### DETAILED DESCRIPTION

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, systems, devices, and methods for initiating a loan payoff are disclosed according to various embodiments described herein. In some instances, the systems, devices, and methods described herein allow for users to scan a product identifier, such as a serial number found on a product unit or a contract number, and pay off an outstanding balance relating to the product corresponding to the product identifier. A mobile device resource (e.g., an application) associated with a provider institution (e.g., financial institution) may allow a user to initiate a payoff of a loan or other outstanding balance. Beneficially, the mobile device resource may examine all (or, in some embodiments, a select grouping of) user financial accounts linked with a user account to determine which user accounts, if any, the user can make payments on behalf of. In some embodiments, the loan payoff may be initiated through a third-party resource, such as a dealer management system (DMS). Furthermore, the systems, devices, and methods described herein generate and provide various user interfaces to a device of a user to allow fund transactions, observe fund transaction history, initiate a dispute resolution and various other functionalities described herein.

By way of example, if a business or entity has an inventory of several vehicles and would like to pay off the loan for each of the vehicles, a user (such as a sales representative or some other individual) can scan the product identifier of each vehicle, such as the Vehicle Identification Number (VIN) using the camera of a mobile device. In a mobile application associated with the provider institution where the loan is held, the user can view the loan associated with each VIN. The user is provided a list of actions that are allowed to be performed for the given product. For example, the user can select, from the list of allowable actions, an option to initiate a loan payoff and pay the remaining balance of the loan.

In various embodiments, the resource of the mobile device can extract characters corresponding to the product identifier of a product identified in an image taken by the camera of the mobile device. The resource can initiate a request to a server that includes the extracted characters belonging to the identifier and information corresponding to the list of accounts linked with the user profile. The server can return, to the resource, data corresponding to the product. The data may include the loan terms, the interest rate, or the accrued interest. The resource can display the information relating to the data.

In some embodiments, the user may select, from the list of allowable actions, to execute a payment. Beneficially, executing a payment includes initiating a transfer of funds from an account according to a payment amount indicated in the information relating to the product. In some embodiments, the allowable action taken by the user is staging a payment. Staging a payment includes adding the product identifier to a queue for executing the payment for the product by a second user. The second user may be a user associated with one of the accounts linked to the profile of the first user. Beneficially, the user can execute or stage payments via a resource of a mobile device without having to manually input the product identifier of each unit the user would like to pay off or view information on.

Technically and beneficially, the disclosure described herein relates to a method of receiving data relating to a loan and paying off the loan. A dealer may have an inventory of products to be sold, and each product may have a loan taken out. The loan may be paid off when a consumer purchases the product from the dealer. The dealer may manually identify each sold product and individually pay off the loan for each product upon selling the product. The dealer may manually input an identification of the product (e.g., a vehicle identification number) for each unit to retrieve information relating to the product and its corresponding loan, and subsequently pay off the loan. Manually inputting information and paying off each loan individually may be time consuming, for example for dealers with a large product inventory.

The present disclosure includes a method of capturing one or more identifiers corresponding to a product and efficiently paying off a loan for the product. Providing an identifier coupled with accounts linked to the profile of the user uploading the identifier may narrow the amount of data that is looked through to retrieve information on the product. This may expedite the delivery of relevant data to the user so that loans can be paid off in a more efficient time frame. Additionally, the ability to upload or scan multiple product identifiers or one purchase order corresponding to multiple products at one time may decrease an amount of time to complete multiple payments. For example, a purchase order may include an order of 150 (one-hundred and fifty) computers. Instead of inputting an identifier of each computer into the resource to pay off each item individually, scanning the purchase order may populate the product identifiers of each computer so that all of the items can be paid for in one action. Further, the resource displaying relevant loan information and allowable actions to be performed relating to the loan may reduce confusion or uncertainty for a user when paying off a loan.

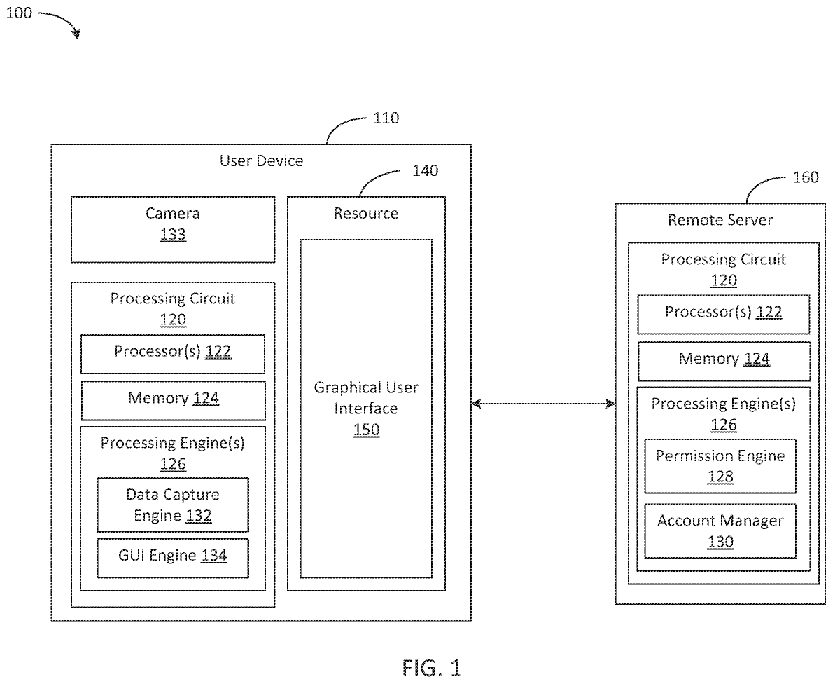

FIG. 1 is a diagram of a system 100 for initiating a quick loan payoff, according to an example embodiment. The system 100 may include a user device 110. The user device 110 may be or include any device, component, element, or hardware designed or configured to be handled or used by an end user. In some embodiments, the user device 110 may be a mobile phone and/or a smartphone.

The user device 110 may include a resource 140. The resource 140 may be or include any device, component, element, or hardware designed or configured to be an application installed on the user device 110. In some embodiments, the resource 140 may be a mobile banking application for a financial institution. A user can use their user credentials to access the resource 140. The resource 140 can authenticate the user based on the user credentials. In some embodiments, a server 160 hosting the resource 140 executing on (or provisioned to) the user device 110 authenticates the user credentials. For example, the resource 140 may be configured to receive log-in credentials of the user, and transmit the log-in credentials of the user to the server 160. An account manager 130 of the server 160 (described in greater detail below) may be configured to access a user profile corresponding to the log-in credentials, and determine whether the log-in credentials received from the resource 140 match the log-in credentials of the user profile. In some embodiments, the server 160 may use multi-factor authentication to authenticate the user to access the resource 140. Such multi-factor authentication may include, for example, push notifications, biometric authentication, username and password combinations, and so forth.

In various embodiments, the resource 140 may include, execute on, or otherwise be provisioned by a server 160. The server 160 may be or include any device, component, element, or hardware designed or configured to enable an interaction between a user of the device 110 and data of the resource 140. In some embodiments, the server 160 may provide functionality and communication capabilities for the resource 140. For example, the resource 140 may be hosted on, executed on, and/or provisioned by the server 160 to the device 110.

In various embodiments, the server 160 and/or user devices 110 may include respective processor circuits(s) 120. The processing circuit(s) 120 may be or include any device, component, element, or hardware designed or configured to execute actions or processes. For example, the processing circuit(s) 120 may be configured to execute, support, provision, or otherwise provide the resource 140. In some embodiments, the processing circuit(s) 120 may include one or more processor(s) 122 and memory 124. The processor(s) 122 may be or include a field programmable gate array (FPGA), application specific integrated circuit (ASIC), a logic circuit, etc. The memory 124 may include random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory 124 may be embodied as a non-transitory computer readable medium storing instructions executable by the processor 122 to perform various functions of the device 110/remote server 160 disclosed herein. In some embodiments, the memory 124 and the processor 122 are integrated as a single component. The processing engine(s) 126 may be or include any device, component, element, or hardware designed or configured to perform certain dedicated functions of the processing circuit 120, the server 160, and/or the user device 110. For example, the processing engine(s) 126 may include a permission engine 128, an account manager 130, a data capture engine 132, and a graphical user interface engine 134. The processing engine(s) 126 may enable the functions of the permission engine 128, the account manager 130, the data capture engine 132, and the graphical user interface engine 134. The permission engine 128, the account manager 130, the data capture engine 132, and the graphical user interface engine 134 are described in greater detail herein.

In various embodiments, the processing engine(s) 126 may include a permission engine 128. The permission engine 128 may or be or include any device, component, element, or hardware designed or configured to determine a set of allowable actions the user can take within the resource 140. The permission engine 128 may determine, based on the user credentials and/or a user profile associated with a user's user credentials, the set of allowable actions. The set of allowable actions may be related to a document or product the user is viewing information on. In various embodiments, the set of allowable actions may be related to the settings of the user profile that have been enabled by an administrator of the account. For example, if the user is an employee of a company, a manager of the user can select, via the permission engine 128, which actions the user is allowed to perform. The user profile may be tagged with certain actions set by a manager or administrator. For example, the permission engine 128 may receive, from a manager or administrator profile, selected actions to be enabled for a user profile. The permission engine 128 may tag the user profile according to the selected allowable actions such that the user can perform the selected actions. The set of allowable actions may include receiving information relating to products, initiating a dispute, staging payments, or executing payments. The permission engine 128 may receive the selection of an action to be taken from the set of allowable actions. The resource 140 or another component of the resource 140 (e.g., the processor 122) may perform the action according to the selection. For example, a first user may have a set of corresponding allowable actions that only includes receiving information relating to products, while a second user has a second set of corresponding allowable actions that include receiving information relating to products, initiating a dispute, staging payments, and executing payments. Accordingly, each user of a set of multiple users (e.g., within a company) may have a corresponding and distinct set of allowable actions.

In various embodiments, the processing engine(s) 126 may include an account manager 130. The account manager 130 may determine a list of accounts that are linked to the user profile. The accounts linked to the user profile may include accounts that belong to a business, employer, or other entity associated with the user. For example, if a user is referencing a loan on a car for a car dealership the user is employed at, the account manager 130 may be configured to identify or determine a linked account (e.g., a master account) associated with the car dealership. The account manager 130 may be configured to identify the accounts by performing a look-up function using a user identifier from the user profile (e.g., received at log-in via the resource 140), in the memory 124 (or other data structure), to identify each of the linked accounts associated with the user identifier. If the product the user is referencing on the resource is associated with multiple users, the users may be listed under the linked accounts. For example, if the user is looking at a loan on a car for a car dealership the user is employed at, a linked account may be an account of a supervisor of the user. A user may have accounts linked to their user profile that are not associated with a specific product or document. For example, a linked account may belong to a supervisor at the user's place of employment and can view any loans the user has access to.

The processing engine(s) 126 may include a data capture engine 132. The data capture engine 132 may be configured to control the user device 110 to capture an image. In some embodiments, the data capture engine 132 may be deployed at the user device 110, and configured to automatically control the camera 133 of the user device 110 to capture the image (e.g., change the direction, focus, field of view, etc.). In some embodiments, the data capture engine 132 may be configured to control the camera 133 of the user device 110, to capture the image and upload the image to the server 160 hosting the resource 140. In some embodiments, the image is of a product identifier corresponding to a product. Examples of product identifiers can include, but are not limited to, a loan number, a vehicle identification number (VIN), a serial number, an inventory number, a purchase order number, or an identifier corresponding to a bill of lading. In some embodiments, the data capture engine 132 can be configured to extract the characters which correspond from the product identifier from the captured image. In various embodiments, the data capture engine 132 can be configured extract characters of the product identifier by executing or otherwise using an optical character recognition (OCR) software package.

In some embodiments, the resource 140 can initiate a request to the remote server 160. In some embodiments, the request includes the product identifier and information corresponding to a list of accounts linked to the profile. The account manager 130 can retrieve information corresponding to the product requested in the request. The information corresponding to the product may include, but is not limited to, a balance due associated with a loan against the product, loan terms of the loan, accrued interest, or an interest rate. The account manager 130 can transmit the data corresponding to the product to the resource 140. The graphical user interface engine 134 may be configured to update the graphical user interface 150 of the resource 140, to display the information received by the resource 140 from the remote server 160. In some embodiments, the data displayed includes the set of allowable actions the user is allowed to perform.

In various embodiments, the allowable actions permitted to be taken by the user may be related to the product or document that the user is currently viewing. For example, a user may be an employee of a car dealership. If the user is viewing a car loan that a car dealership has taken out for a car, the user may be able to stage a payment and execute a payment. The user may stage and/or execute the loan payment after a customer has purchased the car. If the user is instead viewing, for example, the dealership's car loan for a vehicle that has been put on hold but not yet purchased, the user may be able to stage a payment. The resource 140 or another component of the user device 110 (e.g., the processor 122) may perform the action according to a selection by the user. In various embodiments, executing a payment may include the resource 140 initiating a transfer of funds from a first account. The account may be, for example, a checking account associated with the user. The payment may be of an amount indicated by the data corresponding to the product that is received from the remote server 160 (and determined by the account manager 130 responsive to the request). In various embodiments, the staging of the payment may include adding the product identifier to a queue. The queue may be for executing payment by a second user. The steps for executing the payment may be the same as or similar to the steps described herein. In various embodiments, a second user may execute the payment if the first user is unable or unauthorized to take the action of executing a payment. In various embodiments, after a user has selected an allowable action to perform and the action has been performed, the resource 140 may receive a notification (e.g., from the server 160) that indicates that the action has been completed.

In various embodiments, the resource 140 may receive a user input to initiate a dispute relating to a product or document. A dispute may be initiated, for example, based on a purchase order number and/or an identifier corresponding to a bill of lading associated with the purchase order. In some embodiments, the data capture engine 132 may determine a first count of products corresponding to the purchase order. For example, the resource 140 may utilize OCR software to extract a purchase order number. The data capture engine 132 may communicate to a remover server 160 to retrieve information corresponding to the purchase order number. The information may include a product count. In some embodiments, the data capture engine 132 may have the data from the purchase order stored (e.g., in memory 124 locally, in a remote data structure accessible to the user device 110, etc.). The data capture engine 132 may be configured to perform OCR to extract a product count from the purchase order. The data capture engine 132 may further receive a second count of received products. In some embodiments, a user may input a count of received products to the resource 140 (e.g., to a graphical user interface 150 displayed on the resource 140 including a field for receiving the count of products received in connection with the purchase order). The data capture engine 132 may be configured to transmit the data to initiate the dispute. In various embodiments, the data may include the first count, the second count, and the identifier of the purchase order. The data may be transmitted to, for example, a remote server 160 or another resource of the device 110.

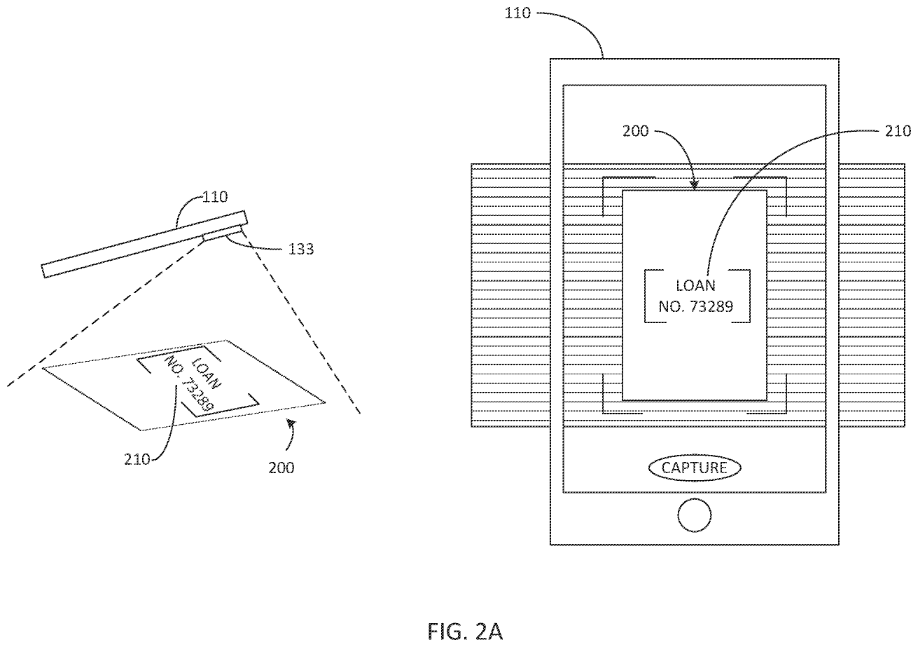

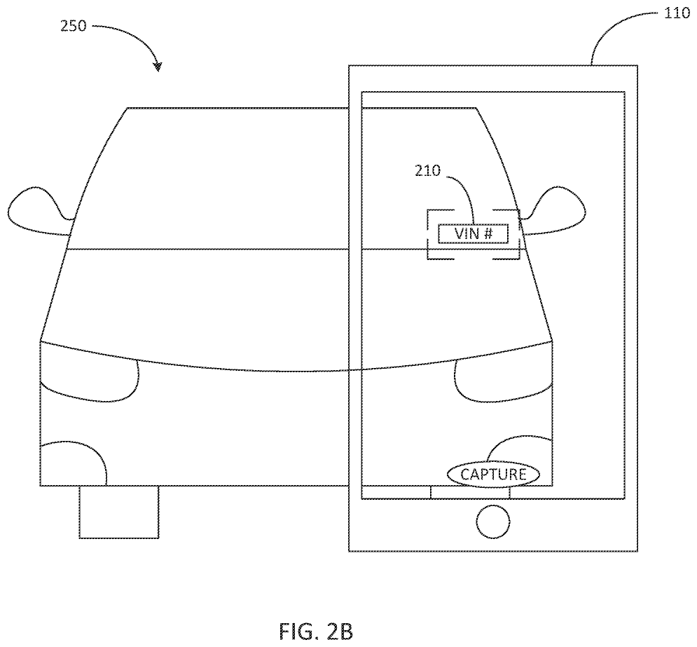

Referring now to FIG. 2A, depicted is an example environment in which the systems and methods described herein may be used, according to an example embodiment. In the example shown in FIG. 2A, a user device 110 may be used to capture an image of a product identifier, according to an example embodiment. Document 200 may be a loan, purchase agreement, or any other document indicating an agreement between a lender and a borrower. The document 200 can include a product identifier 210, shown in FIG. 2A as a loan number. The product identifier 210 may be a unique string of characters that correspond to and uniquely identify the document 200. In various embodiments, a camera 133 of the user device 110 can capture the product identifier 210 of the document 200 by scanning or photographing the document 200. In various embodiments, data capture engine 132 may be configured to control the camera 133 to capture the image of the identifier (e.g., change direction, focus, field of view, etc.). The data capture engine 132 may be configured to parse the image of the identifier, to identify, extract, or otherwise determine the product identifier 210 of the document 200. For example, the data capture engine 132 may be configured to execute and use OCR software to extract the characters from the image The data capture engine 132 may be configured to upload, transmit, communicate, or otherwise provide the captured image and/or extracted data to the server 160 hosting the resource 140.

FIG. 2B depicts another environment in which a product identifier 210 may be captured, according to an example embodiment. In various embodiments, the product identifier 210 may be a vehicle identification number (VIN) or other identifier found on a product. For example, as shown in FIG. 2B, the product 250 is a vehicle and the product identifier 210 is the VIN of the vehicle 250. In various embodiments, the product identifier 210 may be printed on a sticker or other element adhered or affixed to the product 250. In various other embodiments, the product identifier 210 may be integrally formed on the product 250 (e.g., engraved on the product). In the embodiment shown in FIG. 2B, the product identifier 210 is a VIN printed on a sticker that is adhered to the vehicle 250. Similar to FIG. 2A, the camera 133 of the user device 110 can capture the product identifier 210 by photographing product 250 with the product identifier in view. For example, as shown in FIG. 2B, the data capture engine 132 can control the camera 133 of the user device 110, to capture a VIN number of a vehicle by scanning the tag on the vehicle. In various embodiments, the data capture engine 132 of the user device 110 may be able to identify the product identifier 210 of the product 250 and extract the unique characters of the product identifier. The data capture engine 132 may be configured to execute an OCR algorithm or executable, to extract or otherwise determine the characters of the product identifier. The data capture engine 132 may be configured to transmit, communicate, upload, or otherwise provide the captured image and/or product identifier 210 to the server 160 hosting the resource 140. In various embodiments, the server 160 may be configured to extract and/or identify the characters from the image of the product identifier 210 using OCR software (e.g., rather than extraction occurring locally at the user device-side).

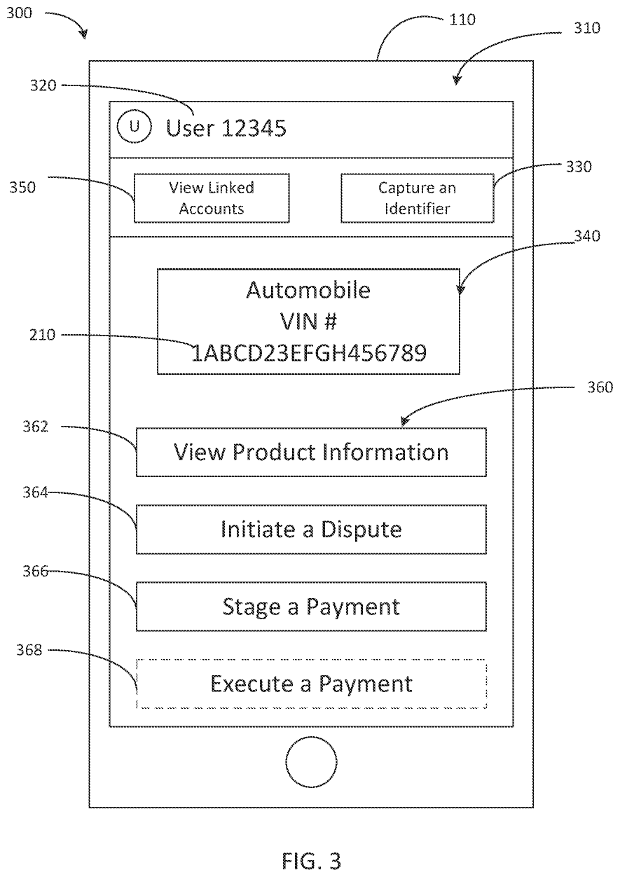

Referring now to FIG. 3, depicted is an example graphical user interface 300 of the resource 140 on a user device 110. The graphical user interface 300 may be the same or similar to the graphical user interface 150. The graphical user interface 300 depicted in FIG. 3 includes one embodiment of a display page 310 for a user of the resource 140. The graphical user interface 300 of FIG. 3 may be one of various displays that the resource 140 can display. In the exemplary embodiment of FIG. 3, the display page 310 corresponds to a display after a user has captured a product identifier 210 and uploaded the image to the resource 140. Upon logging into the resource 140 using user credentials, a user profile header 320 can be displayed on the display page 310. The user profile header 320 may include the logged in user's name, nickname, and/or other identifying information corresponding to the user's profile associated with the resource 140. When the user is logged into the resource 140, the user can capture a product identifier 210 using a camera 133 of the user device 110.

As shown in FIG. 3, the user may select option (or user interface element) 330 to capture a product identifier 210. Selecting option 330 may cause a pop-up to display on the graphical user interface 300 prompting the user to select to capture an image using the camera 133 of the user device 110, scan a product identifier using the camera 133, upload an image stored in the user device 110, and/or other options to capture a product identifier 210 and upload it to the server 160 hosting the resource 140. After capturing the product identifier, the user can view the product identifier 210 at block 340. Alternatively and/or additionally, the block 340 may include what type of product and/or product identifier the captured characters are from. For example, as shown in FIG. 3, block 340 identifies the type of product 250 the identifier corresponds to (i.e., a vehicle), the type of product identifier 210 (i.e., a VIN number), and the product identifier 210.

Before and/or after the user has uploaded an image of the product identifier 210 and/or performed an action such that the data capture engine 132 has identified the characters corresponding to the product identifier 210, the user may view linked accounts at block 350 of the graphical user interface 300. The linked accounts may be accounts of other users of the resource 140 that the user can interact with. The linked accounts that a user can interact with may depend on the document 200 or product 250 and its corresponding product identifier 210 that the user is presently viewing information for (i.e., the product identifier has been uploaded to the resource). In various embodiments, the accounts linked to the user profile may vary depending on the product identifier uploaded to the resource 140. The linked accounts for a document 200 or product 250 may include any users that are able to perform an action relating to the document 200 or product 250. For example, one linked account may be authorized to perform payment-related actions for the document 200 or product 250. In various embodiments, one linked account may be for a user authorized as an administrator. An administrator may be able to assign, to other users, actions they are allowed to take relating to the document 200 or product 250. In various embodiments, there may be a master account that may be similar to an administrator account, that can be linked to customer accounts. For example, a master account may correspond to an owner of a business and customer accounts may correspond to employees of the business. In various embodiments, the master account and/or administrator account may be the linked account able to perform payment-related actions.

Referring still to FIG. 3, the user can view actions 360 related to the document 200 or product 250. Actions may include, but are not limited to, viewing product information, initiating a dispute, staging a payment, and/or executing a payment. In various embodiments, not all actions 360 may be able to be taken by the user. For example, if a linked account has assigned actions to other users' linked accounts, one user may not be able to perform one or more actions. For example, as shown in FIG. 3, actions 362, 364, and 366 are considered to be “allowable” actions, designated by a solid line around the action. An allowable action may be one that a user is authorized to perform. As shown in FIG. 3, action 368 is an “unallowable” action, as indicated by a dashed line around the action. An unallowable action may be one that a user is not authorized to perform. In various embodiments, one or both of allowable actions and unallowable actions may be indicated by various other methods, not solid and/or dashed lines (e.g., unallowable actions are grayed out and allowable actions are not). In various embodiments, after an allowable action has been performed, the graphical user interface 300 may display a notification indicating that the action has been completed.

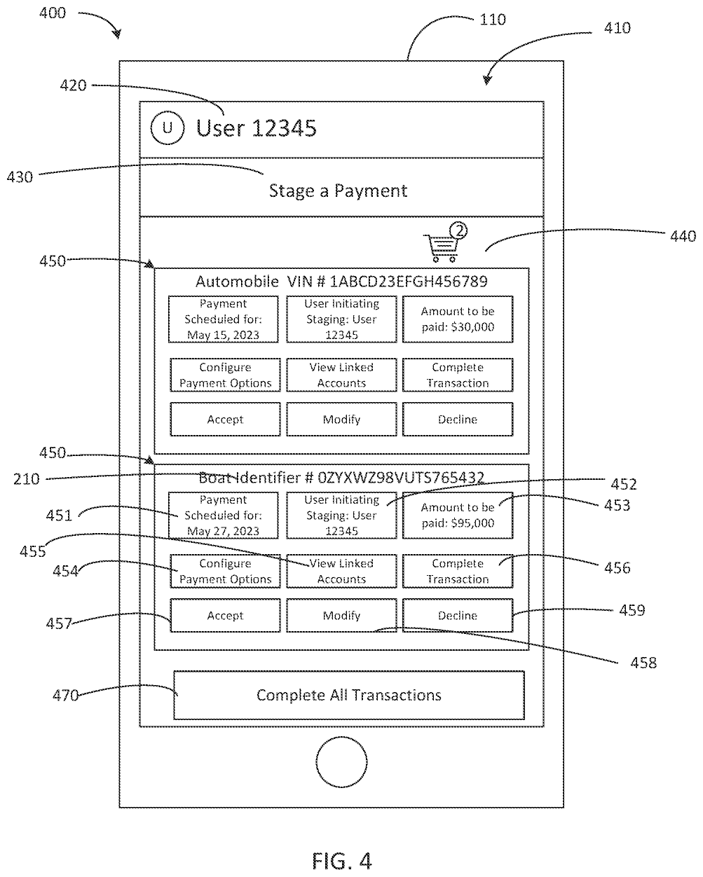

Referring now to FIG. 4, depicted is an example graphical user interface 400 involving the staging of a loan payment displayed on a customer device 110, according to an example embodiment. The display page 410 shows an example embodiment of a page for staging a payment on the resource 140. At the top of the page 410, the user profile 420 is identified. The user profile 420 may correspond to the user logged into the resource 140. Identifier 430 may indicate the display page 410 of the resource 140 that the device 110 is showing. According to the embodiment shown in FIG. 4, the identifier 430 indicates that the display page 410 is for staging a payment. In some embodiments, the identifier 430 may display, for example, “executing a payment” if the device 110 is displaying a page for executing a payment.

Icon 440 may indicate a number of items that the user has staged a payment for. For example, if a payment is staged for two individual loans, the icon 440 may indicate that with a numeral “2”, as shown in FIG. 4. In various embodiments, block 450 indicates an item that has been staged for payment. The block 450 may include the product identifier 210 to indicate the item associated with the payment being staged.

The block 450 may also include a plurality of viewable items and/or action items to take regarding the staging of the payment of the product. For example, block 451 indicates a date on which the staged payment may be executed. Block 452 may indicate the user that staged the payment for the item. In various embodiments, the user that staged the payment may be identified by a user identification number. In various embodiments, the user may be identified by a name or other identifier, such as an employee number. Block 453 may indicate the loan amount that is to be paid. In various embodiments, the price indicated in block 453 may be the total amount of the loan (e.g., the entirety of the loan is to be paid off at one time). In various embodiments, a user may be able to stage multiple payments for one product. For example, if a user is staging payment of a $90,000 loan, multiple payments may be staged, meaning the loan may be paid off in increments. For example, if a $90,000 loan is to be paid off in three increments, the block 453 may indicate that the amount to be paid for one staged payment may be $30,000.

Block 454 may indicate an option to configure payment options and/or view payment information for the loan. For example, selecting block 456 may trigger a page or pop-up window to display. The page or pop-up window may include information, such as a bank account number, from where the funds may be taken to make the payment. At block 455, linked accounts may be viewed. The linked accounts may be linked to the specific loan. In various embodiments, the linked accounts may be linked generally to the user profile (e.g., a linked account is a master account for the company at which the user is employed). Block 456 may indicate an option to configure payment options and/or view payment information for the loan. For example, selecting block 456 may trigger a page or pop-up window to display. The page or pop-up window may include information, such as a bank account number, from where the funds may be taken to make the payment. At block 456, the user may be able to complete the transaction for the staged payment at the time the user selects the option (e.g., selecting option 456 may override the scheduled payment date shown in block 451).

At block 457, the user can accept the staged payment. In various embodiments, accepting the staged payment may mean accepting the information regarding the staged payment (e.g., payment date, payment method, payment amount, etc.). At block 458, information related to the staged payment may be modified. For example, a user may change a bank account from which funds are taken to execute the loan payment. If one or more of the items shown in blocks 451 through 456 should be modified, the user may be able to modify the data by first selecting block 458 and further selecting the information to modify. At block 459, a user may decline the staged payment. In various embodiments, a manager or administrator may be authorized to accept, modify, and/or decline a staged payment. A manager or administrator may authorize additional users to accept, modify, and/or decline staged payments.

At block 470, a user may select to complete all staged payments. For example, if three loan payments have been staged, selecting block 470 may complete all payments at that time. In various embodiments, selecting block 470 may accept all staged payments. For example, in some embodiments, selecting block 470 may mean that payments are be executed on the scheduled date shown in block 451.

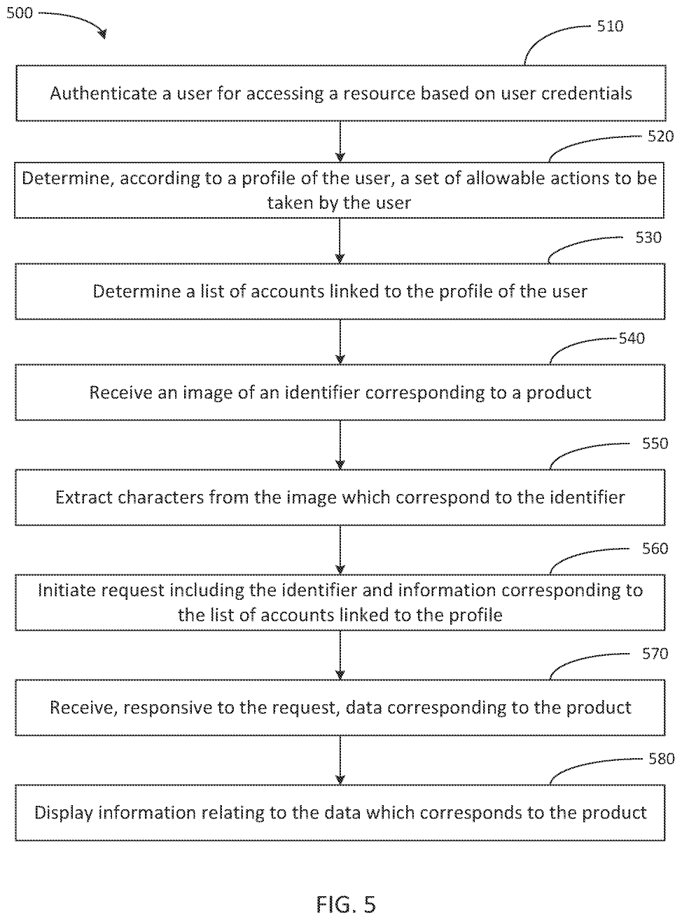

Referring now to FIG. 5, depicted is a flowchart of a system 500 for initiating a quick loan payoff, according to an example embodiment. The steps of system 500 may be performed by the systems, devices, components, elements, or other hardware described above with reference to FIG. 1. At step 510, a user is authenticated, by a resource of a user device, to access the resource based on the user credentials. At step 520, the resource determines a set of allowable actions to be taken by the user according to the profile of the user. At step 530, the resource determines a list of accounts that are linked to the profile of the user. At step 540, the resource receives an image of a product identifier that corresponds to a product. At step 550, the resource extracts characters from the captured image of step 540 which correspond to the product identifier. At step 560, a request is initiated by the resource. The request can include the identifier and information corresponding to the list of accounts linked to the profile. At step 570, the resource receives, in response to the request, data corresponding to the product identified by the product identifier. At step 580, the resource displays information relating to the data which corresponds to the product identified by the product identifier.

At step 510, a user is authenticated, by a resource of a user device, to access the resource based on the user's individual user credentials. The resource may authenticate the user responsive to receiving an input of the user credentials by the user. For example, the resource may authenticate the user after receiving an input of the user's username and password for the resource. Responsive to the user opening the resource on the user device, the server may request the username and password inputs on the resource. The resource may communicate the information to the server after the user has input their credentials. The server may authenticate the credentials and allow access to the resource. In some embodiments, the server may perform multi-factor authentication to authenticate the user. Such multi-factor authentication can include various combinations of authentication methods, including username and password, biometric scans, push notifications, etc.

At step 520, the resource determines a set of allowable actions to be taken by the user according to the profile of the user. In some embodiments, the set of allowable actions may include at least one of receiving information relating to products, initiating a dispute, staging payments, or executing payments. The resource may determine the set of allowable actions responsive to the user credentials being authenticated in step 510. For example, a user profile may have a predetermined set of allowable actions associated with the account that are generated responsive to a user's credentials being authenticated. The resource may determine the set of allowable actions from the server of the resource. For example, responsive to authenticating the user credentials, the server of the resource (i.e., server 160) may retrieve the set of allowable actions associated with the user credentials. As previously discussed herein, each user of a set of multiple users (e.g., within a company) may have a corresponding and distinct set of allowable actions.

At step 530, the resource determines a list of accounts that are linked to the profile of the user. In some embodiments, the list of accounts linked to the profile may include, for example, an account associated with the company at which the user is employed. The resource may determine a list of accounts linked to the profile of the user responsive to the resource authenticating the user. The resource may determine the list of accounts by receiving data from a server (e.g., server 160) including information about a user profile of the user. The server may perform a look-up function (e.g., in memory or in another accessible data store) using an account identifier associated with the user profile, to determine a one or more linked accounts associated with or linked to the account identifier. For example, the user profile may be linked to an account belonging to a supervisor of the user. The server may transmit data to the user device, indicating the linked accounts associated with the user profile.

At step 540, the resource receives an image of a product identifier that corresponds to a product. The image of the product identifier may be captured by a camera of the mobile device. In some embodiments, the product identifier may be or include at least one of a vehicle identification number, a serial number, an inventory number, a purchase order number, or an identifier corresponding to a bill of lading. The camera may capture the product identifier responsive to a user input to the resource selecting to capture an identifier. The resource may receive the image of the product identifier responsive to the camera capturing the image and/or a user selecting to upload the image to the resource. The user may capture a product identifier to view information relating to the product, such as a loan on the product. The camera of the user device may capture the product identifier by scanning or taking a photo of the product such that the product identifier is visible and/or legible in the photo. In various embodiments, the resource may control the hardware camera of the user device, to capture the image including the product identifier.

At step 550, the resource extracts characters from the captured image of step 540 which correspond to the product identifier. In some embodiments, the resource (e.g., executing locally) and/or the data capture engine of the device, may extract the characters of the captured image using optical character recognition (OCR) software. The resource may extract the characters from the captured image responsive to the resource receiving the image. In some embodiments, the user device may communicate/transmit/upload/provide the image to the server 160, to perform character extraction, and return the product identifier to the user device for display via the resource. In some embodiments, OCR software may be installed on the device and/or resource of the device such that character extraction may be performed locally.

At step 560, a request is initiated by the resource. The request can include the identifier and information corresponding to the list of accounts linked to the profile. The request may be directed to a server. In some embodiments, the information corresponding to the list of accounts may include a company or business associated with the linked accounts. The resource may initiate the request responsive to the resource extracting the characters of the product identifier. Extracting the characters of the product identifier may allow the resource to initiate the request with data used by the server to retrieve the correct information. The request may be initiated through a server of the resource (e.g., server 160), to request data from the server.

At step 570, the resource receives, in response to the request, data corresponding to the product identified by the product identifier. In some embodiments, the data corresponding to the identified product may be related to financial data (e.g., a loan on the product, a remaining balance of the loan, etc.). The resource may receive data corresponding to the product from the server 160 responsive to the server retrieving the requested data from one or more data stores. In some embodiments, the data may be stored locally at the server. In some embodiments, the server may retrieve or otherwise request the data (e.g., via one or more API calls) from a third-party server.

At step 580, the resource displays information relating to the data which corresponds to the product identified by the product identifier. In some embodiments, the information may include a balance due associated with a loan against the product, loan terms of the loan, accrued interest, and an interest rate. The resource may display the information responsive to converting the data received from the server responsive to the request, into a format to be displayed on the resource. The resource may display the information on a graphical user interface (GUI) of the resource.

In various embodiments, the method 500 may further include receiving, by the resource, a selection of an action from the set of allowable action determined in step 520. The resource may receive a selection of an action from a user responsive to the user viewing the information corresponding to the product in step 580. The actions may include one or more of the actions shown on FIG. 3 described above. In various embodiments, the method 500 may further include performing, by the resource, the action according to the selection. The resource may perform the action responsive to the selection of the action. The resource may perform the action by communicating, to a server (e.g., remote server 160), information related to the performing of the action such that the action may be executed.

In various embodiments, the method 500 may further include receiving, by the resource, a notification indicating completion of the action. The resource may receive a notification indicating completion of the action responsive to receiving the selection of the action and performing the action. The notification may be generated by a server (e.g., server 160) upon completion of the action and transmitted to the resource. In various embodiments, the action performed by the resource includes executing a payment. Performing the action (i.e., executing a payment) may include initiating, by the resource, a transfer of funds from a first account. The funds may be determined according to a payment amount indicated in the data corresponding to the product received at step 580 of the method 500.

In various embodiments, the action performed by the resource includes staging a payment. Performing the action (i.e., staging a payment) may include adding the identifier to a queue for executing payment for the product by a second user. In various embodiments, the second user may be a user authorized to execute a payment (e.g., the first user is not authorized to execute a payment). The resource (e.g., executing on a second device of the second user) may determine if a user is authorized to execute a payment at step 520, by communicating the user credentials of the second user to the server and receiving the set of allowable actions to be take by the user.

In various embodiments, the identifier captured by the camera at step 540 may be a purchase order number or an identifier corresponding to a bill of lading associated with the purchase order. The action performed by the resource may include initiating a dispute corresponding to the purchase order. In various embodiments, initiating a dispute corresponding to the purchase order may include determining, by the resource, a first count of products corresponding to the purchase order. The resource may determine the first count of products by using OCR software to extract characters indicating a product count on the purchase order. For example, the resource may use OCR software to scan a purchase order and determine that the first count of products (i.e., a number of products ordered) is, for example, 20.

Initiating a dispute may further include receiving, by the resource, a second count of received products. The resource may receive the second count of products via the user. The second count of products may be, for example, a number of products actually received by the user. In various embodiments, a dispute may be initiated if the first product count is different than the second product count (e.g., the user did not receive the same number of products as was ordered). The user may upload, to the resource, information indicating the second count of products (e.g., a photo of the products received, a receipt of products received, etc.).

Initiating a dispute may further include transmitting, by the resource, to a device (such as a device corresponding to the server 160), data to initiate to the dispute. The data may include, for example, the first count, the second count, and the identifier. The data may be transmitted to the device via communication between the resource and an external server (e.g., server 160). The data may be transmitted responsive to the first count and the second count of the products being received by the resource. For example, the resource may transmit the data to initiate the dispute, responsive to the first count being different from the second count.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method, comprising:
authenticating, by a resource of a mobile device, a user for accessing the resource based on user credentials of the user;
determining, by the resource, according to a profile of the user, a set of allowable actions to be taken by the user;
determining, by the resource, a list of accounts linked to the profile of the user;
receiving, by the resource, an image of an identifier corresponding to a product, the image captured by a camera of the mobile device;
extracting, by the resource, characters from the image which correspond to the identifier;
initiating, by the resource, a request to a server, the request comprising i) the identifier and ii) information corresponding to the list of accounts linked to the profile;
receiving, by the resource from the server, responsive to the request, data corresponding to the product; and
displaying, by the resource, information relating to the data from the server which corresponds to the product, including the set of allowable actions permitted to be performed.

2. The method of claim 1, wherein the set of allowable actions comprise at least one of receiving information relating to products, initiating a dispute, staging payments, or executing payments.

3. The method of claim 1, wherein the identifier comprises at least one of a vehicle identification number, a serial number, an inventory number, a purchase order number, or an identifier corresponding to a bill of lading.

4. The method of claim 1, wherein the information includes a balance due associated with a loan against the product, loan terms of the loan, accrued interest, and an interest rate.

5. The method of claim 1, further comprising:
receiving, by the resource, a selection of an action from the set of allowable action; and
performing, by the resource, the action according to the selection.

6. The method of claim 5, wherein the action comprises executing payment, wherein performing the action comprises initiating, by the resource, a transfer of funds from a first account, according to a payment amount indicated in the data corresponding to the product.

7. The method of claim 5, wherein the action comprises staging payment, wherein performing the action comprises adding the identifier to a queue for executing payment for the product by a second user.

8. The method of claim 5,
wherein the identifier comprises at least one of a purchase order number or an identifier corresponding to a bill of lading associated with the purchase order, and
wherein the action comprises initiating a dispute corresponding to the purchase order.

9. The method of claim 8, wherein performing the action comprises:
determining, by the resource, a first count of products corresponding to the purchase order;
receiving, by the resource, a second count of received products; and
transmitting, by the resource, to a device, data to initiate to the dispute, the data comprising the first count, the second count, and the identifier.

10. The method of claim 5, further comprising:
receiving, by the resource, responsive to receiving the selection and performing the action, a notification indicating completion of the action.

11. A server comprising:
one or more processors configured to:
receive, from of a resource of a mobile device, a user log in attempt via user credentials of the user;
transmit an authentication of the user log in attempt to the resource;
retrieve information corresponding to the user profile of the user, wherein the information corresponding to the user profile of the user is at least one of a set of allowable actions to be taken by the user, or a list of accounts linked to the profile of the user;
transmit the information corresponding to the user profile of the user to the resource of the mobile device;
receive, from the resource, characters that correspond to an identifier of a product;
receive a request from the resource, the request comprising i) the identifier and ii) information corresponding to the list of accounts linked to the profile; and
transmit, to the resource, responsive to the request, data corresponding to the product.

12. The server of claim 11, wherein the set of allowable actions comprise at least one of receiving information relating to products, initiating a dispute, staging payments, or executing payments.

13. The server of claim 11, wherein the identifier comprises at least one of a vehicle identification number, a serial number, an inventory number, a purchase order number, or an identifier corresponding to a bill of lading.

14. The server of claim 11, wherein the data corresponding to the product includes a balance due associated with a loan against the product, loan terms of the loan, accrued interest, and an interest rate.

15. The server of claim 11, further configured to:
receive, from the resource, a selection of an action from the set of allowable action; and
perform, by the server, the action according to the selection.

16. The server of claim 15, wherein the action comprises executing payment, wherein performing the action comprises initiating, by the server, a transfer of funds from a first account, according to a payment amount indicated in the data corresponding to the product.

17. The server of claim 15, wherein the action comprises staging payment, wherein performing the action comprises adding the identifier to a queue for executing payment for the product by a second user.

18. The server of claim 15,
wherein the identifier comprises at least one of a purchase order number or an identifier corresponding to a bill of lading associated with the purchase order, and
wherein the action comprises initiating a dispute corresponding to the purchase order; and
wherein performing the action comprises:
determining, by the server, a first count of products corresponding to the purchase order;
receiving, by the server, a second count of received products; and
transmitting, to the resource, by the server, data to initiate to the dispute, the data comprising the first count, the second count, and the identifier.

19. The server of claim 15, further configured to:
transmit, to the resource, by the server, responsive to receiving the selection and performing the action, a notification indicating completion of the action.

20. A device comprising:
one or more processors configured to execute a resource, the resource configured to:
authenticate a user for accessing the resource based on user credentials of the user;
determine, according to a profile of the user, a set of allowable actions to be taken by the user;
determine a list of accounts linked to the profile of the user;
receive an image of an identifier corresponding to a product, the image captured by a camera of the device;
extract characters from the image which correspond to the identifier;
initiate a request to a server, the request comprising i) the identifier and ii) information corresponding to the list of accounts linked to the profile;
receive, from the server, responsive to the request, data corresponding to the product; and
display information relating to the data from the server which corresponds to the product, including the set of allowable actions permitted to be performed.
